(19) United States
(12) Patent Application Publication
(10) Pub. No.: US 2023/0015899 A1
(43) Pub. Date: Jan. 19, 2023

(54) DEVICE FOR INTERRUPTING AN ELECTRICAL CIRCUIT

(71) Applicant: DEUTSCHES ZENTRUM FÜR LUFTUND RAUMFAHRT E. V., Bonn (DE)

(72) Inventors: Stefan GEISSENDÖRFER, Oldenburg (DE); Holger BEHRENDS, Rhauderfehn (DE); Gerrit BREMER, Oldenburg (DE)

(21) Appl. No.: 17/787,323

(22) PCT Filed: Dec. 18, 2020
(86) PCT No.: PCT/EP2020/087232

§ 371 Date: Jun. 19, 2022

(30) Foreign Application Priority Data
Dec. 20, 2019 (DE) 10 2019 135 459.5

(51) Int. Cl. H01H 1/02

(52) U.S. Cl. CPC H01H 1/02

(57) ABSTRACT

The invention relates to a device for interrupting or closing an electrical circuit. The invention further relates to a method of interrupting or closing an electrical circuit. An inventive circuit interruption device for interrupting an electrical circuit contains a contact piece comprising a ceramic material.

The invention relates to a device for interrupting or closing an electrical circuit. Furthermore, the invention relates to a method of interrupting or closing an electrical circuit.

It is known to interrupt electrical circuits by means of a switch. The circuit can be interrupted by use of a contact switching element, on the basis of semiconductor components or by a combination of both (e.g. DC hybrid switches). The disadvantage of semiconductor switches is a relatively high forward resistance which makes them rather unsuitable for continuous use as an interruption component at higher electrical outputs. In addition, they do not achieve a real galvanic isolation.

Typically, with power applications, electrical circuits are interrupted by the separation of two or more contact pieces. In case of an interruption of electrical circuits with contact switching elements, an electric arc is produced when the contacts are opened, which is due to an ionization of the air because of high electrical fields during the interruption process and the emission of charge carriers from the contact surfaces due to overcoming of the respective work function (e.g. thermionic emission).

When the contacts of electrical switches are opened, the electric resistance rises abruptly, leading to a high rate of change of the current which in turn causes a high potential difference over the arc gap. This difference, together with the emission of charge carriers from the contact surfaces, is one reason for the creation of an electrically conducting arc over the arc gap. In conventional switching devices, units are employed the task of which is to extinguish the arc in different ways, terminally interrupting the electrical circuit. For instance, arc extinction chambers or arcing chambers which are filled with gases or evacuated can be used. In most switching devices, the arc chamber consists of individual iron sheets which are electrically isolated from each other and over which the arc produced during the switching process is distributed. By discharge of the arc heat to the quenching plates and the additional voltage drop due to the arc distribution, energy is withdrawn from the arc and arc extinction is facilitated. Such an extinction chamber is disclosed e. g. in document EP 0 176 870 A2.

In addition, in a.c. voltage networks, the fact is exploited that the electric current and the electric voltage have periodic current zeros. The extinction strategies employed use this characteristic to extinguish the arc at the times of current zeros.

In direct voltage networks, these current zeros do not exist in normal operation. In the case of direct voltage, the objective of such extinction strategies is to increase the voltage above the arc such that it rises above the feeding voltage. The current is consequently reduced and finally extinguished.

Thus, in case of direct voltage, it requires more effort to extinguish an arc and thus interrupt the circuit than with alternating voltage. In direct voltage applications, hybrid switches are used ever more often which largely avoid the disadvantages of both types of switches, contact switches and semiconductor-based switches, to the detriment of complexity.

It is an object of the invention to disclose a circuit interruption device by means of which an electrical circuit can be interrupted, at the same time minimizing the indicated disadvantages. Furthermore, it is an object of the invention to disclose a method by means of which an electrical circuit can be interrupted while minimizing the indicated disadvantages.

According to the invention, this object is achieved by means of a circuit interruption device having the features of the independent claim 1. Advantageous further developments of the circuit interruption device can be found in dependent claims 2 through 9. Furthermore, the object of the invention is achieved by a method according to claim 10. Advantageous further developments of the method can be found in dependent claims 11 and 12.

A circuit interruption device for interrupting an electric circuit according to the invention has a contact piece, the contact piece comprising a ceramic material, the ceramic material being doped.

In an advantageous embodiment, the contact piece has a plurality of sub-pieces with ceramic material of different conductivities. The ceramic material can be provided with different conductivities e.g. by differently doping the ceramic material used for the respective sub-piece.

In another advantageous embodiment, the contact piece is coated with a ceramic material. For instance, the contact piece can consist of a ductile basic material coated with a ceramic material. Thus, the disadvantage of high brittleness of ceramic materials can be ameliorated or even compensated.

In another embodiment, the contact piece is entirely made of the ceramic material. Such a contact piece takes less effort to produce than a coated contact piece.

In another advantageous embodiment, the circuit interruption device has a plurality of contact pieces.

In an additional advantageous embodiment, the plurality of contact pieces is arranged in pairs, in each pair of contact pieces one movable contact piece being arranged movably with respect to a second contact piece. The second contact piece can be fixed or movable as well. The most common embodiment comprises a circuit interruption device with one movable and one fixed contact piece. Switching takes place by relative movement of the movable contact piece with respect to the second, fixed contact piece. If the second contact piece is movable as well, relative movement takes place by means of the movement of both contact pieces.

It has proven advantageous if the circuit interruption device is adapted to provide the current to be switched with a current path over the ceramic material at each stage of the interruption process. The current path can have different conductivities depending on the stage of the interruption process which in particular decrease during shutdown. The conductivity can change continuously or quasi-continuously. “Continuously” means that conductivity changes from each point to every other point. “Quasi-continuously” means that the conductivity changes in discrete steps, the increments being small enough so that the effect is substantially analogous to a continuous change.

It has proven to be advantageous if each current path over the ceramic material is dimensioned such that the starting criteria for arc initiation are not met. This can reliably prevent striking of an arc.

In the inventive method of interrupting an electrical circuit, an inventive circuit interruption device is used where a plurality of contact pieces cooperate.

In this method, it has proven advantageous if different sub-pieces of a contact piece are introduced into the circuit during the interruption process.

In an advantageous embodiment, the various sub-pieces of a contact pieces are introduced into the circuit by shifting a contact piece with respect to another contact piece. In this manner, the electric resistance in the electrical circuit to be interrupted is continuously increased, with the current being reduced according to the rules of electrotechnology. By continuous or quasi-continuous change in the resistance, which in any case is not abrupt, the voltage over the interruption member, or the electric field intensities, are smaller than in the case of abrupt opening of the contacts in conventional switches. An ionization of the air is avoided and no arc is produced. During the interruption process, the current is offered at any time a current path alternative to the air via the ceramic material. This path is dimensioned such that the starting criteria for arc initiation are not met. Conventionally, the energy which is stored in the electrical circuit to be interrupted is converted in the arc during the interruption process. In the inventive interruption concept which avoids the formation of arcs, this energy is instead converted into thermal energy in the ceramic material or into the electrical resistance thereof. The heat resistance of the ceramic material is advantageously exploited during this process.

The various sub-pieces of a contact piece can be arranged on the fixed, on the movable or on both contact pieces. Because manufacturing of a contact piece with sub-pieces requires more effort, it has proven advantageous to form only one contact piece, in particular the fixed contact piece, from sub-pieces.

Some terminology will be explained in the following:

First, it is explicitly pointed out that within the framework of the present patent application, indefinite articles and numerals such as “one”, “two” etc. are normally to be understood as indicating a minimum, i.e. “at least one . . . ”, “at least two . . . ” etc. unless it becomes explicitly clear from the context or is obvious to the person skilled in the art or indispensable from a technical point of view that only “exactly one . . . ”, “exactly two . . . ” etc. can be intended. The term “plurality” indicates a number larger than one, i.e. in particular a number of (exactly) two can be intended.

An arc is produced if the difference in electrical potential, i.e. electrical voltage, and the current density due to impact ionization are high enough. Gas discharge forms a plasma in which the particles, i.e. atoms or molecules, are at least partially ionized. The free charge carriers cause the gas to become electrically conductive. Most plasmas are practically neutral; that is, the number of ions and electrons are identical. Since the ions are much slower than the more lightweight electrons, frequently electrons are almost exclusively relevant to current transport. Arcs occurring in electrical power engineering during switching actions are called switch arcs. A switch arc is a serial arc produced when two electrical contacts through which current flows are separated. Switching sparks and switch arcs are generated because after the contacts have been opened, the electrical current continues to flow in the form of a spark discharge or an arc discharge. In the case of closed contacts, the current is distributed nearly homogeneously. When the contact is separated, first a concentration of current density at the last point of contact takes place. If the contact is opened further, the arc is then formed at this point or points between the contacts. The reason for this is the low electric strength of the insulating material, such as the air, between the contacts which are not yet separated very far, causing these insulating materials to be ionized. Such a discharge is additionally promoted if at the moment of mutual separation of the contacts, hot points are produced at the chopping points due to the flow of current over a small cross-section with high current densities, the hot points leading to thermionic emission and a re-supply of metal ions. Due to impact ionization as in a gas discharge, the running voltage is now lowered, impeding interruption.

A ceramic material is a material containing ceramics. The term “ceramics” designates a group of anorganic, non-metallic materials which are poorly soluble in water and by at least 30% crystalline. Ceramic materials are normally formed from a raw mass at ambient temperature and obtain their typical material properties from a temperature treatment generally above 800° C. The term “non-metallic” here refers to the properties of the pure material, such as electrical conductivity, thermal conductivity and ductility. In particular, ceramic materials are electrically insulating, highly temperature-resistant, and have a strong hardness and abrasion resistance.

Doping designates the introduction of foreign atoms into a layer or a base material. The amount of foreign atoms introduced is very small in comparison to the carrier material and amounts to e.g. between 0.1 and 100 ppm. The foreign atoms form imperfections in the base material and alter the properties of the starting material, i.e. the behavior of the electrons and thus electrical conductivity, in a targeted manner Even a low density of foreign atoms can cause a major change in electrical conductivity. The degree of conductivity depends on the type and amount of foreign atoms introduced. There are different doping methods, such as diffusion, electrophoresis, resublimation or bombardment with high-energy particle accelerators under vacuum (ion implantation).

Coating is the application of a strongly adhesive layer of an amorphous material on the surface of a workpiece. A thin layer, a thick layer or several coherent layers can be applied. In terms of application of the coating, chemical, mechanical, thermal and thermomechanical methods can be distinguished.

The term interruption device designates a device which can interrupt an electrical circuit. In this document, the term “interruption device” is to indicate a device which can also close the circuit, i.e. be used as an on-off switch. The greatest challenge in designing such a device is commonly the interruption of the circuit.

The current to be switched is an electric current whose flow is to be switched off or on. Current is a physical entity in electrical engineering designating the transport of electrical charge carriers, that is e.g. of electrons in conductors or semiconductors or of ions in electrolytes. In an electrical circuit, a current flows if a conductive connection between the connectors of the source is established. The physical unit for intensity of the electric current is the amperage with the legal unit ampere. Current flows via current paths, which may be predefined current paths e.g. in the form of electrical conductors. A current path can, however, be also created by the situation. For instance, current can also flow over an arc as a current path, and this may be desired or undesired.

Other advantages, particularities and advantageous further developments of the invention will become clear from the dependent Claims and the following presentation of preferred examples of embodiment by means of the figures.

In the figures:

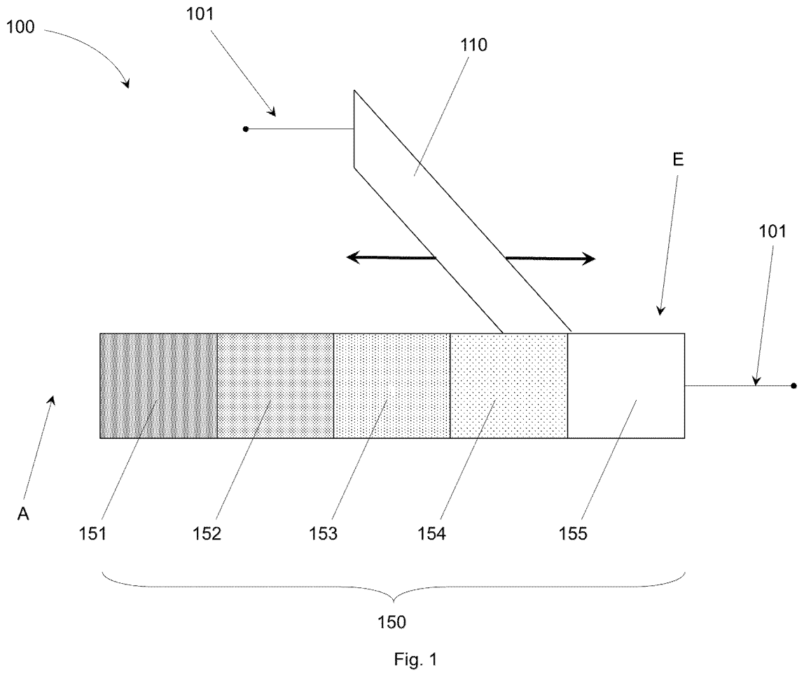

FIG. 1 shows a schematic structure of a circuit interruption device according to the invention with a stepwise, quasi-continuous change in conductivity;

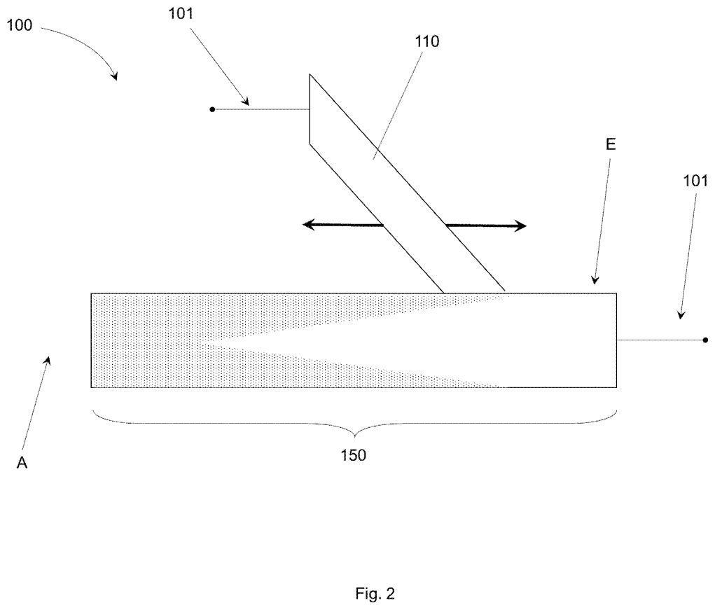

FIG. 2 shows a schematic structure of a circuit interruption device according to the invention with a continuous change in conductivity;

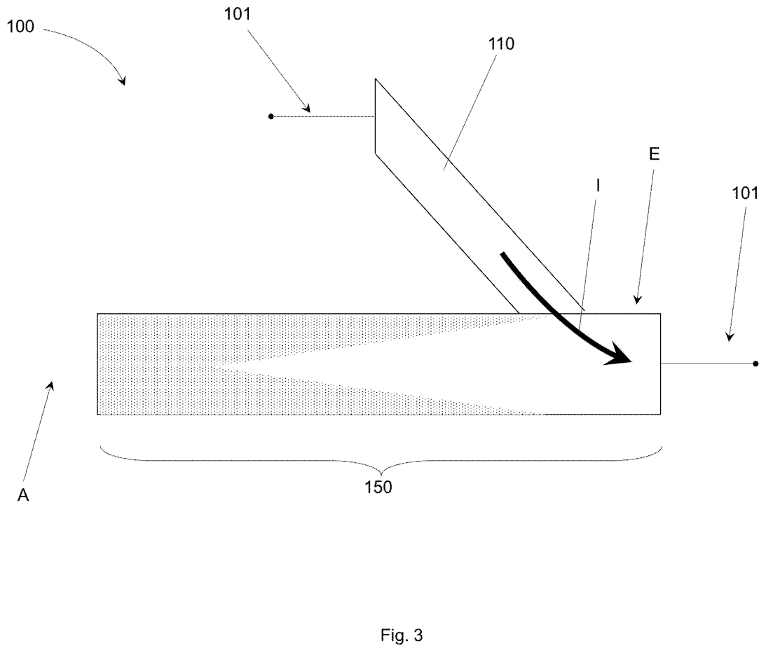

FIG. 3 shows the basic interruption process with the circuit interruption device according to the invention with the movable contact piece in a first position;

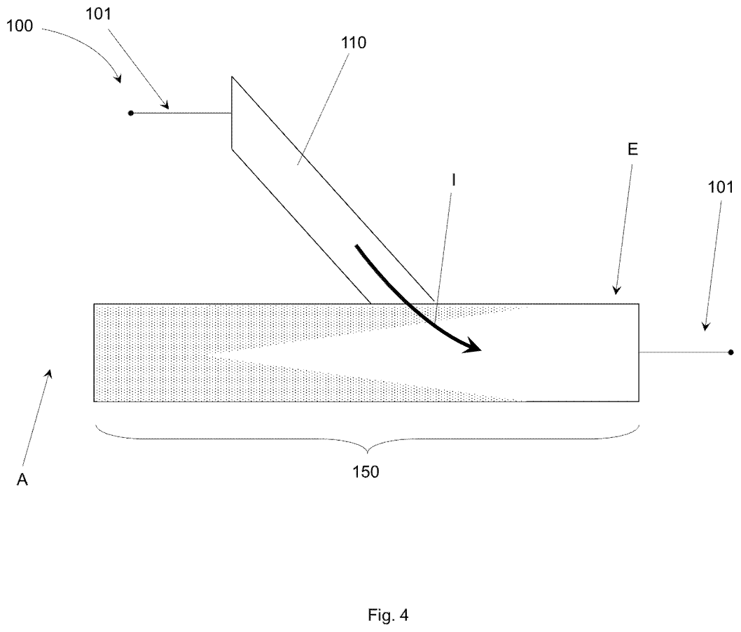

FIG. 4 shows the basic interruption process with the circuit interruption device according to the invention with the movable contact piece in a second position;

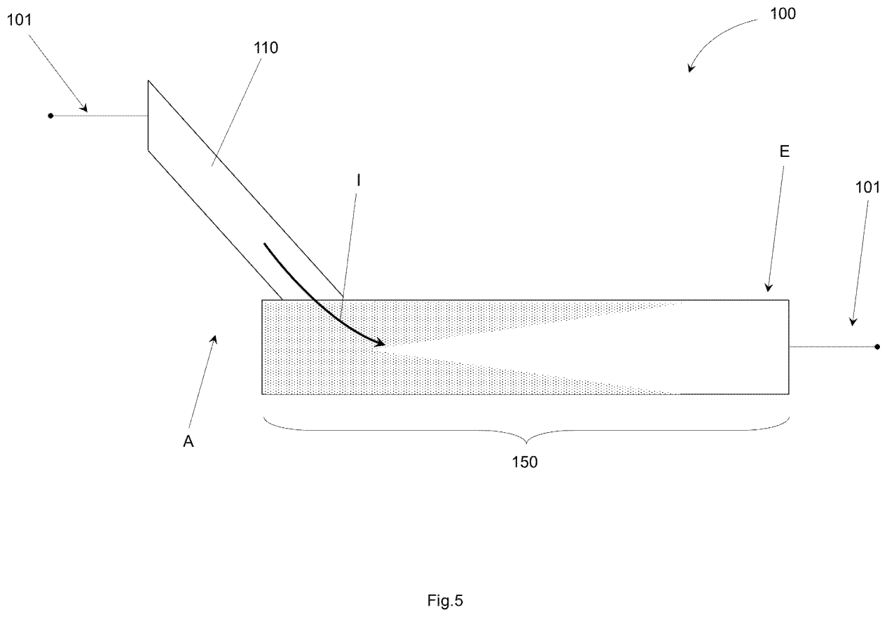

FIG. 5 shows the basic interruption process with the circuit interruption device according to the invention with the movable contact piece in a third position;

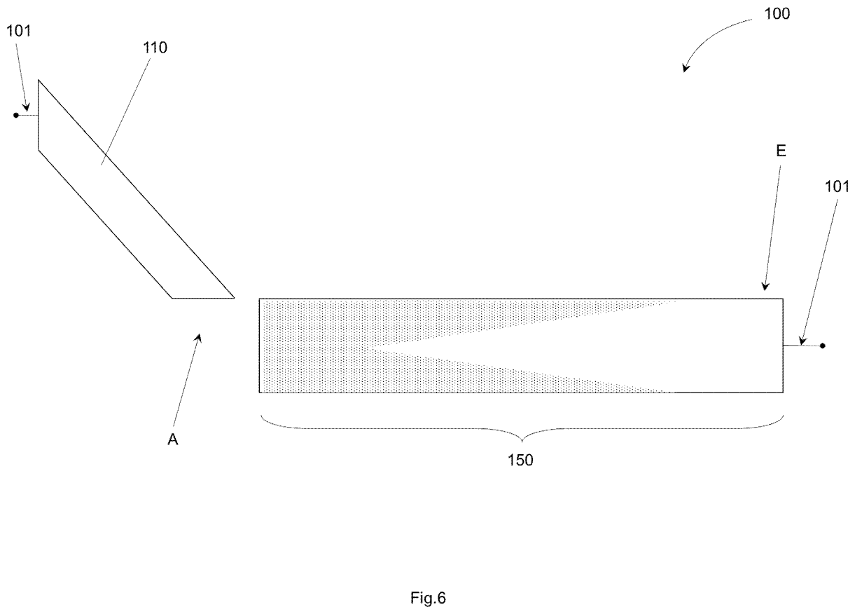

FIG. 6 shows the basic interruption process with the circuit interruption device according to the invention with the movable contact piece in an off position.

FIG. 1 shows a schematic structure of a circuit interruption device 100 according to the invention with a stepwise, quasi-continuous change in conductivity. The circuit interruption device 100 has a fixed contact piece 150 and a movable contact piece 110. The contact pieces are connected to the electrical circuit to be interrupted via connections 101. The fixed contact piece 150 shown in FIG. 1 has a series of different resistance stages in the form of sub-pieces 151, 152, 153, 154, 155, the conductivity increasing from the first sub-piece 151 via the additional sub-pieces 152, 153 and 154 up to the last sub-piece 155. The sub-pieces 151, 152, 153, 154 are coated with a ceramic material which has different stages of doping such that conductivity varies in the manner described above. The fifth sub-piece 155 can be non-coated so that in the position in which the movable contact piece 110 contacts the fifth sub-piece 155, a current path is available which has full conductivity. For example, the movable contact piece 110 and the fifth sub-piece 155 can consist of a metal with metallic surface, in particular a metal with good electric conductivity, such as e.g. copper or a copper alloy. By shifting the movable contact piece 110 over the sub-pieces 155, 154, 153, 152, 151, the current to be switched is offered current paths with decreasing electrical resistance. The sub-pieces 151, 152, 153, 154, 155 can be small such that the electrical resistance decreases quasi-continuously, in particular not abruptly.

FIG. 2 shows a schematic structure of a circuit interruption device 100 according to the invention with continuous change in conductivity. The fixed contact piece 150 has a continuous shape of ceramic material which sheathes the fixed contact piece. By sliding of the movable contact piece 110 over this continuous shape of the ceramic material, a continuous rise in electrical resistance is allowed. Possible courses can be a linear, a square or an exponential rise in electrical conductivity from the on position E to the off position A.

FIG. 3 shows the basic interruption process with the circuit interruption device 100 according to the invention with the movable contact piece 110 in a first position. In the on position E of the movable contact piece 110 on the fixed contact piece 150, which is shown in FIG. 3, the circuit connected by connections 101 is closed. An electrical current I flows via the movable contact piece 110 through the fixed contact piece 150.

FIG. 4 shows the basic interruption process with the circuit interruption device 100 according to the invention with the movable contact piece 110 in a second position. During the interruption process, the movable contact piece is shifted to the left on the fixed contact piece 150 in the direction of the off position A and the ceramic material is introduced into the electrical circuit, increasing electrical resistance and decreasing current intensity I which is represented by a weaker intensity of the arrow I.

FIG. 5 shows the basic interruption process with the circuit interruption device 100 according to the invention with the movable contact piece 110 in a third position. The farther the movable contact piece 110 is shifted to the left into the off position A, the more ceramic material, possibly with different dopings, is introduced into the circuit and the stronger the electrical resistance of the circuit interruption device 100 becomes.

FIG. 6 shows the basic interruption process with the circuit interruption device 100 according to the invention with the movable contact piece 110 in an off position A. At the end of shifting of the movable contact piece 110 on the fixed contact piece 150, it is possible to mechanically separate the movable contact piece 110 from the fixed contact piece 150 and thus to galvanically separate the circuit without creation of an arc.

The embodiments shown here are only examples of the present invention and are therefore not to be intended as limiting. Alternative embodiments considered by the person skilled in the art are equally comprised by the scope of protection of the present invention.

### LIST OF REFERENCE NUMBERS

100 circuit interruption device
101 connection to circuit
110 movable contact piece
150 fixed contact piece
151 first sub-piece of fixed contact piece
152 second sub-piece of fixed contact piece
153 third sub-piece of fixed contact piece
154 fourth sub-piece of fixed contact piece
155 fifth sub-piece of fixed contact piece
E on position
A off position
I current

1. Circuit interruption device for interrupting an electrical circuit, comprising a contact piece, the contact piece comprising a ceramic material, wherein the ceramic material is doped.

2. Circuit interruption device according to claim 1,
wherein the contact piece contains a plurality of sub-pieces, the sub-pieces comprising ceramic material of different conductivities.

3. Circuit interruption device according to claim 1, wherein the contact piece comprises a coating with a ceramic material.

4. Circuit interruption device according to claim 1, wherein the contact piece is made of the ceramic material.

5. Circuit interruption device according to claim 1, wherein the circuit interruption device has a plurality of contact pieces.

6. Circuit interruption device according to claim 5, wherein the plurality of contact pieces is arranged in pairs, in each pair of contact pieces one movable contact piece being arranged movably with respect to a second contact piece.

7. Circuit interruption device according to claim 6, wherein the second contact piece is embodied as a fixed contact piece.

8. Circuit interruption device according to claim 1, wherein the circuit interruption device is adapted to provide the current to be switched with a current path over the ceramic material at each stage of the interruption process.

9. Circuit interruption device according to claim 8, wherein the current path over the ceramic material is dimensioned such that the starting criteria for arc initiation are not fulfilled.

10. Method of interrupting an electrical circuit, wherein a circuit interruption device according to claim 1 is employed, with a plurality of contact pieces cooperating.

11. Method according to claim 10, wherein during the interruption process, various sub-pieces of a contact piece are introduced into the circuit.

12. Method according to claim 11, wherein the various sub-pieces of a contact piece are introduced into the circuit by shifting of a contact piece with respect to another contact piece.
